(19) United States
(12) Patent Application Publication
(10) Pub. No.: US 2026/0241522 A1
(43) Pub. Date: Aug. 20, 2026

(54) PRESSING TOOL COMPRISING A PAIR OF TOOL PARTS FOR CRIMPING A PRESSED PART AS WELL AS PAIR OF TOOL PARTS FOR A PRESSING TOOL

(71) Applicant: GUSTAV KLAUKE GMBH, Remscheid (DE)

(72) Inventors: Matej STRNISA, Wetter (DE); Sonja Martina HELL, Wermelskirchen (DE); Egbert FRENKEN, Heinsberg (DE)

(73) Assignee: GUSTAV KLAUKE GMBH, Remscheid (DE)

(21) Appl. No.: 19/161,630

(22) PCT Filed: Mar. 6, 2024
(86) PCT No.: PCT/EP2024/055863

§ 371 Date: Sep. 2, 2025

(30) Foreign Application Priority Data
Mar. 6, 2023 (DE) 20 2023 101 054.7

(51) Int. Cl. B25B 27/10

(52) U.S. Cl. CPC B25B 27/10

(57) ABSTRACT

A pressing tool includes a pair of tool parts which can be brought together by tool jaws in a bringing-together direction. In response to brought-together tool parts, a receiving region for the pressed part remains in each tool part. Each tool part has ribs having an essentially triangular contour assigned to the receiving region for crimping a pressed part. A guide protrusion protrudes beyond the ribs and comes into contact with the pressed part and with a guide receptacle guides and centers the respective other tool part. The tool jaws pivot between open and closed positions on a circular path in response to the bringing together and the guide protrusion of the one tool part in the open position is outside of the guide receptacle of the other tool part in the bringing-together direction. The guide protrusion moves into the guide receptacle as part of the bringing together.

### FIELD OF TECHNOLOGY

The invention relates to a pressing tool comprising a pair of tool parts for crimping a pressed part formed as cable end sleeve with a cable core of a cable, and comprising two tool jaws, which can be brought together, for the exchangeable holding of the tool parts, wherein the pair of tool parts has a first tool part and a second tool part, which can be brought together by means of the tool jaws in a bringing-together direction, wherein, in response to brought-together tool parts, a receiving region for the pressed part remains in each tool part, wherein the tool parts each have a plurality of ribs assigned to the receiving region for crimping the pressed part by means of application of force, wherein, in a front view, in which a front surface serving the purpose of the application of pressure onto the pressed part is reproduced as line, the ribs, based on an effective region on the pressed part, have an essentially triangular contour, wherein, in this view, two opposite triangular contours of the same tool part complement each other to two longitudinal sides, which run at an angle to one another, of a rectangle of the receiving region, wherein the ribs further have a longitudinal extension transversely to a bringing-together direction given in the mentioned view, wherein, in the bringing-together direction, the tool parts further have a guide protrusion protruding beyond the ribs, which come into contact with the pressed part, and a guide receptacle, for the guiding and centering cooperation as part of a bringing together of the tool parts with a guide protrusion and a guide receptacle of the respective other tool part, and wherein the tool jaws pivot between an open position and a closed position on a circular path.

The invention furthermore relates to a pressing tool comprising a pair of tool parts for crimping a pressed part with a cable core of a cable, and comprising two tool jaws, which can be brought together, for exchangeably holding the tool parts, wherein the pair of tool parts has a first tool part and a second tool part, which can be brought together by means of the tool jaws in a bringing-together direction, wherein, in response to brought-together tool parts, a receiving region for the pressed part remains in each tool part, wherein the tool parts each have a plurality of ribs assigned to the receiving region for crimping the pressed part by means of application of force, wherein a height extension of the ribs is directed in the direction of the opposite tool part, and wherein, viewed orthogonally to a movement plane, in which the tool parts can be brought together, the tool parts have guide protrusions protruding beyond the ribs, which come into contact with the pressed part, in the bringing-together direction, for the guiding and centering cooperation as part of a bringing together of the tool parts.

In addition, the invention relates to a pair of tool parts for a pressing tool.

### PRIOR ART

Pressing tools and tool parts of the type in question, in particular pressing tools formed as hand tools for crimping a pressed part are known in the prior art. By using them, a pressed part, for example a cable end sleeve, can be pressed with a cable core of a stripped cable, in order to establish an electrically conductive connection. Pressing tools of the above-mentioned type are known, for example, from published patent applications EP 3 904 007 A1 (US 2021/0336399 A1) or U.S. Pat. No. 6,151,950 A.

In addition to manually operated pressing tools, hydraulically and/or electrically operated pressing tools are also known. The pairs of tool parts are inserted into the tool jaws of the pressing device, wherein a crimping of the pressed part with an exposed cable end can be performed.

### SUMMARY OF THE INVENTION

Based on the above-described prior art, the invention has the object of specifying a pressing tool for crimping a pressed part, by means of which an advantageous crimping result can be attained. In particular, a function of the pressing tool is to also be ensured, without the risk of a canting or blocking, respectively, of the tool parts during the crimping process.

A possible solution of the object is given according to a first idea of the invention in the case of a pressing tool comprising a pair of tool parts for crimping a pressed part formed as cable end sleeve with a cable core of a cable, and comprising two tool jaws, which can be brought together, for exchangeably holding the tool parts, wherein the pair of tool parts has a first tool part and a second tool part, which can be brought together by means of the tool jaws in a bringing-together direction, wherein, in response to brought-together tool parts, a receiving region for the pressed part remains in each tool part, wherein the tool parts each have a plurality of ribs assigned to the receiving region for crimping the pressed part by means of application of force, wherein, in a front view, in which a front surface serving the purpose of the application of pressure onto the pressed part is reproduced as line, the ribs, based on an effective region on the pressed part, have an essentially triangular contour, wherein, in this view, two opposite triangular contours of the same tool part complement each other to two longitudinal sides, which run at an angle to one another, of a rectangle of the receiving region, wherein the ribs further have a longitudinal extension transversely to a bringing-together direction given in the mentioned view, wherein, in the bringing-together direction, the tool parts further have a guide protrusion protruding beyond the ribs, which come into contact with the pressed part, and a guide receptacle, for the guiding and centering cooperation as part of a bringing together of the tool parts with a guide protrusion and a guide receptacle of the respective other tool part, and wherein the tool jaws pivot between an open position and a closed position on a circular path, wherein the tool parts comprising the tool jaws pivot on the circular path in response to the bringing together and wherein the guide protrusion of the one tool part in the open position is outside of the guide receptacle of the other tool part in the bringing-together direction, and wherein the guide protrusion moves into the guide receptacle as part of the bringing together.

In a given open state of the tool jaws, a guide protrusion of the one tool part is moved out of the guide receptacle of the other tool part in any case. At the start of the bringing together, preferably after a few angular degrees of the circular movement, for example two or more angular degrees, further for example after 5, 10, 15 or more angular degrees, the guide protrusion of the one tool part moves into the guide receptacle of the other tool part. With the tool jaws pivoting on a circular path, the tool parts fastened thereto also pivot in response to bringing together the tool parts on the circular path. In addition, the pivoting of the tool parts takes place from the open position, in the case of which the at least one guide protrusion of the first tool part is positioned completely outside of the at least one guide receptacle of the second tool part, to the closed position, in which the guide protrusion engages with the corresponding guide receptacle and thus effects a lateral offset and/or longitudinal offset of the tool parts. The guide protrusion thereby moves into the corresponding guide receptacle only as part of the bringing together of the tool parts. Each tool part can thereby have one or several guide protrusions or one or several guide receptacles, respectively, for corresponding guide protrusions. In response to a bringing together of the tool parts, starting at a completely separated state during the open position, the guide protrusions serve the purpose of a pre-centering of the tool parts relative to one another. The guide protrusions can be formed in the shape of individual protruding ribs, pins or the like, wherein they engage with corresponding guide receptacles of the respective opposite tool part in response to bringing together the tool parts and thus correct a possible lateral offset and/or longitudinal offset of the tool parts relative to one another. The ribs of the tool parts are thus also simultaneously positioned to one another in order to ensure an unhindered bringing-together of the tool jaws, if possible, and to in particular prevent a canting or blocking of the ribs. The crimping process can thus be performed with optimal result.

It is proposed that the ribs have a height extension in the bringing-together direction. The free end regions of the ribs thus point in the bringing-together direction of the tool parts, namely in the direction of the front surface of the opposite tool part serving the purpose of a pressing effect on the pressed part.

The guide protrusion can be formed as extension of the rib in the bringing-together direction and thus in the height extension. According to this design, the guide protrusion is located at the position of a rib and can essentially simulate the shape of a rib of the tool part, wherein the height extension of the guide protrusion, however, is greater than the height extension of the rib. The tool part has a row of ribs located one behind the other, based on the defined front view, wherein at least one of the ribs may be replaced by a guide protrusion. The guide protrusion thus has a height extension, which is greater than the height extension of the adjacent ribs, so that in the front view, the guide protrusion protrudes farther in the bringing-together direction with its free end region than the adjacent ribs.

Based on a cross section orthogonally to a height extension of the guide protrusions, the guide protrusions can furthermore have an essentially rectangular shape with two long sides and two short sides, wherein the long sides are oriented parallel to a movement plane, in which the tool parts can be brought together, and parallel to the ribs.

In an open state of the pressing tool, the ribs and guide protrusions of the opposite tool parts can be completely disengaged from one another. Due to the parallel alignment of the ribs as well as the parallel direction of the long sides of the guide protrusions to the movement plane, a guidance and centering takes place in particular in the case of a spatial offset of the tool parts transversely to the movement plane.

A further possible solution of the object is given in the case of a pressing tool comprising a pair of tool parts for crimping a pressed part formed as cable end sleeve with a cable core of a cable, and comprising two tool jaws, which can be brought together, for exachangeably holding the tool parts, wherein the pair of tool parts has a first tool part and a second tool part, which can be brought together by means of the tool jaws in a bringing-together direction, wherein, in response to brought-together tool parts, a receiving region for the pressed part remains in each tool part, wherein the tool parts each have a plurality of ribs assigned to the receiving region for crimping the pressed part by means of application of force, wherein a height extension of the ribs is directed in the direction of the opposite tool part, and wherein, viewed orthogonally to a movement plane, in which the tool parts can be brought together, the tool parts have guide protrusions protruding beyond the ribs, which come into contact with the pressed part, in the bringing-together direction, for the guiding and centering cooperation as part of a bringing together of the tool parts, wherein, based on a cross section orthogonally to a height extension of the guide protrusions, the guide protrusions have an essentially rectangular shape with two long sides and two short sides, wherein the long sides are oriented parallel to the movement plane and parallel to the ribs.

A pair of tool parts for a pressing tool is also object of the invention, in particular for a use in one of the pressing tools described here, for crimping a pressed part formed as cable end sleeve with a cable core of a cable, and comprising two tool jaws, which can be brought together, for exachangeably holding the tool parts, wherein the pair of tool parts has a first tool part and a second tool part, which can be brought together by means of the tool jaws in a bringing-together direction, wherein, in response to brought-together tool parts, a receiving region for the pressed part remains in each tool part, wherein the tool parts each have a plurality of ribs assigned to the receiving region for crimping the pressed part by means of application of force, wherein a height extension of the ribs is directed in the direction of the opposite tool part, and wherein the tool parts, viewed orthogonally to a movement plane, in which the tool parts can be brought together, have guide protrusions protruding beyond the ribs, which come into contact with the pressed part, in the bringing-together direction, for the guiding and centering cooperation as part of a bringing together of the tool parts, wherein, based on a cross section orthogonally to a height extension of the guide protrusions, the guide protrusions may have an essentially rectangular shape with two long sides and two short sides, wherein the long sides are oriented parallel to the movement plane and parallel to the ribs.

A pair of tool parts for a pressing tool is further object of the invention, in particular for a use in one of the pressing tools described here, for crimping a pressed part formed as cable end sleeve with a cable core of a cable, and comprising two tool jaws, which can be brought together, for exachangeably holding the tool parts, wherein the pair of tool parts has a first tool part and a second tool part, which can be brought together by means of the tool jaws in a bringing-together direction, wherein, in response to brought-together tool parts, a receiving region for the pressed part remains in each tool part, wherein the tool parts each have a plurality of ribs assigned to the receiving region for crimping the pressed part by means of application of force, wherein a height extension of the ribs is directed in the direction of the opposite tool part, and wherein, viewed orthogonally to a movement plane, in which the tool parts can be brought together, the tool parts have guide protrusions protruding beyond the ribs, which come into contact with the pressed part, in the bringing-together direction, for the guiding and centering cooperation as part of a bringing together of the tool parts, wherein each tool part has three or more receiving regions formed next to one another, wherein the tool parts can also be inserted in the pressing tool offset by 180 degrees and receiving regions, which are identical in pairs, are provided, with the exception of a central receiving region, so that an offsetting by 180 degrees of one of the tool parts is made possible without simultaneous offsetting of the other tool part by 180 degrees.

The below-described possible features apply with regard to the pressing tools described here as well as with regard to the pairs of tool parts described here.

The tool parts can each be formed with guide protrusions, which take over a pre-centering of the tool parts relative to one another in response to a closing process of a receiving region of the pressing tool, that is, in response to a bringing together of the tool parts, starting at an open state. In the separated state, at least one plane, which is oriented orthogonally to the movement plane, of a working region of a working head of the pressing tool preferably exists, into which guide protrusions of both opposite tool parts do not protrude simultaneously or in which a guide protrusion of the first tool part and a guide receptacle of the second tool part, which guide receptacle is formed for receiving a guide protrusion, are positioned at least not simultaneously. It can in particular be provided that the ribs and guide protrusions of the opposite tool parts are completely disengaged from one another in an open state of the pressing tool. The guide protrusions can be formed in the shape of individual, protruding ribs, pins or the like. It is essential that based on the bringing-together direction, they protrude with their free end regions beyond the end regions of the ribs, which are formed on the tool parts and which serve the pressing process. It is thus prevented that in response to bringing together the tool parts, an unwanted offset of the tool parts relative to one another and thus a possible collision occurs due to a mechanical play of the pressing tool, in particular in the insert holders, namely tool jaws. Such a collision would obstruct the bringing together or, in the worst case, also block it completely, so that the crimping process could not be carried out. In the case of a pressing tool, the tool jaws of which are moved linearly towards one another as well as in the case of a pressing tool, the tool jaws of which are pivoted relative to one another about an axis of rotation, the guide protrusions run ahead the surfaces of the tool parts effecting a pressing process, in particular the end regions of the ribs. The free end regions of the guide protrusion thus initially become engaged with one another during the bringing together of the tool parts and can effect the guidance and centering during the movement process, before an application of force is exerted for crimping the pressed part. Due to the almost parallel alignment of the ribs and of the long sides of the guide protrusions and the parallel orientation to the movement plane, a guidance and centering in particular takes place transversely to the movement plane.

According to one design, it is proposed that the guide protrusion has a chamfered front region. The chamfer effects that optionally contacting guide protrusions of the opposite tool parts are offset orthogonally to the movement plane of the bringing-together process, i.e., orthogonally to the bringing-together direction and/or also in the movement plane, when the opposite guide protrusions of the first tool part and of the second tool part come into contact with one another on the chamfer. The chamfer is preferably formed all around the front region of the guide protrusion. The chamfer thereby forms a beveled surface on the edge of the front region. This prevents a canting or blocking, respectively, of the tool parts and in particular also of the guide protrusions, provided that they meet one another in the region of their front surfaces. The chamfer preferably has an angle of between 30 degrees and 80 degrees to the plane of the front surface, in particular between 45 degrees and 70 degrees. According to one embodiment, the plane of the front surface can be oriented orthogonally to the movement plane. The chamfer is preferably formed all around the front region and further preferably has a shape, which is continuous over 360 degrees. A lateral offset of a corresponding guide protrusion of the respective opposite tool part can thus be attained all around, i.e., in a direction orthogonally to the movement plane as well as in the movement plane as well as in each direction located therebetween. Based on a cross section of the guide protrusion, the basic shape of the guide protrusions orthogonally to the movement plane of the tool parts can be round oval, rectangular, polygonal or others. Alternatively to a chamfer, it is possible that the front region of the guide protrusions is formed conically, i.e., does not have a flat partial region. According to this design, it can be prevented almost completely that the opposite guide protrusions block in response to a coming together.

It is furthermore proposed that the tool parts have a guide receptacle, which corresponds in shape to the guide protrusion, wherein the first tool part has a guide protrusion and wherein the second tool part has a corresponding guide receptacle for receiving the guide protrusion of the first tool part, and vice versa. In order to provide for the movement even of the guide protrusions in the bringing-together direction in response to bringing together the tool parts, it is provided that the guide protrusions, for example of the first tool part, can engage with corresponding guide receptacles of the second tool part. For this purpose, a guide protrusion of the first tool part and a guide receptacle of the second tool part are in each case formed so as to be opposite in the bringing-together direction, i.e., in a common plane, which is oriented parallel to the movement plane of the tool parts. During the bringing-together process of the tool parts as well as optionally a gliding along one another of corresponding opposite guide protrusions thereby, a dipping of the respective guide protrusion into the opposite guide receptacle provided for this purpose occurs.

The guide receptacle preferably also has a chamfered opening region in order to provide for a glide-in of the guide protrusion, which likewise preferably has a chamfered front region. The chamfer of the guide receptacle preferably has a chamfer angle, which corresponds to the chamfer of the guide protrusion. The further properties of the chamfer can correspond to those of the guide protrusion.

According to one embodiment, it can be provided that the guide receptacle is a material recess within a base body of the tool part carrying the ribs. According to this design, the guide protrusions of a first tool part are introduced into the base body of the second tool part, namely into guide receptacles formed in the base body. For this purpose, the opening regions of the guide receptacles, based on the bringing-together direction of the tool parts, lie upstream of the front regions of the ribs of the tool parts performing the pressing. According to this embodiment, the guide protrusions preferably do not engage between the ribs but directly with material recesses of the base body of the tool part. It is generally possible that the guide receptacles are formed at a different partial region of the base body of the tool part than the ribs, in particular for example outside of the receiving regions of the tool parts. According to an alternative embodiment or in combination thereto, respectively, it can furthermore also be provided that partial regions of the base body, which do not carry any ribs but rather have guide receptacles, the opening regions of which are upstream of the front regions of the ribs in the direction of movement of the tool parts, are formed between the ribs, so that a movement of the front regions of the guide protrusions into the opening regions of the guide receptacles occurs initially in response to moving the tool parts towards one another, and only then to an engagement of the ribs with one another, which are displaced back in the bringing-together direction.

According to a further possible embodiment, it can be provided that the guide receptacle is a free space, which is formed between adjacent ribs and which is limited by the adjacent ribs. According to this design, the guide receptacles are not formed separately in a partial region of the material forming the base body but are in fact formed and limited indirectly by the adjacent ribs, which, due to their spacing and shape, limit free spaces, with which guide protrusions of an opposite tool part can engage. According to a possible embodiment, the guide protrusions can be formed in the manner of lengthened ribs, which, due to their shape and position, are integrated into the structure of the sequence of ribs. According to this formation, for example one or also several ribs can be replaced with a guide protrusion in an array of ribs. The opposite tool parts of the pair of tool parts are thereby formed so as to correspond to one another so that a guide receptacle of a second tool part lies opposite a rib of a first tool part, and vice versa. The bringing together of the tool parts is thereby possible only to an extent, which is allowed due to the length of the protruding guide protrusions. The ribs can generally be formed in a plane parallel to a movement plane of the tool parts as well as orthogonally adjacent thereto and can form a two-dimensional array with rows and columns of ribs in this way. It goes without saying, however, that it is also possible that the ribs only form individual, for example two parallel rows, which are separated from one another by means of the receiving region of the respective tool part.

It is in particular proposed that the tool part is formed point-symmetrically, so that two guide protrusions and/or two guide receptacles of the same tool part are formed so as to lie opposite point-symmetrically with respect to the receiving region. This embodiment is suitable with respect to tool parts, the guide receptacles of which are material recesses within the base body of the tool part as well as for tool parts, in the case of which the guide receptacles are formed between and by means of adjacent ribs, namely by means of free spaces formed between adjacent ribs and limited by the adjacent ribs. It is thus attained in any case that the tool part can also be inserted into the tool jaw of the pressing tool so as to be rotated by 180 degrees. The user thus does not have to pay attention to only a single possible orientation. Based on a center of symmetry of the respective tool part, the guide protrusions lie opposite one another or the guide receptacles lie opposite one another, respectively. In response to an 180 degree rotation of the tool part about the center of symmetry, the formation does not change, i.e., the same tool part, in turn, has a guide protrusion or analogously a guide receptacle, respectively, at the same position within the tool jaw of the pressing tool. As a result, the tool part can have two or more opposite guide protrusions or accordingly two or more opposite guide receptacles, respectively, with respect to the receiving region, wherein the number of the guide protrusions or guide receptacles, respectively, as a whole does not only have to be limited to two. With respect to a view, in which a separating or contact plane, respectively, of the tool part presents itself as surface, a point-symmetrical arrangement of all guide protrusions or accordingly of all guide receptacles, respectively, results. With respect to at least one of its surfaces, a guide receptacle can thereby also be formed by means of a counter guide protrusion of the other tool part. Each tool part can preferably have in particular four guide protrusions. In the case of four guide protrusions, they are preferably each assigned to a corner region of the tool part. According to the invention, a guidance and centering in the circumferential direction of the respective tool part, i.e., parallel to the movement plane of the tool parts as well as orthogonally thereto, namely in particular in the direction of the longitudinal extension of the pressed part, can result due to the guide protrusions or guide receptacles, respectively.

According to a special embodiment, the guide protrusions and the guide receptacles can be formed outside of the receiving region and/or outside of a region, which is spanned as a whole by the consecutive ribs. The guide protrusions are thereby preferably located outside of a partial region of the tool part, in which the ribs, which serve the purpose of pressing the pressed part, are formed. The partial region having the guide protrusions or guide receptacles, respectively, is preferably a material region raised with respect to the front region of the ribs, in which the front regions of the guide protrusions or the openings regions of the guide receptacles, respectively, lie upstream of the front regions of the ribs in the bringing-together direction of the tool parts. It is ensured thereby that in response to the bringing together of the tool parts, the leading and centering cooperation of the guide protrusions or guide receptacles, respectively, takes place initially and only then a meshing of the ribs located opposite in a corresponding manner in the tool parts.

It can also be provided that the ribs, in turn, have chamfered front regions. Moving the ribs past one another is then simplified, in turn, thereby. The chamfer of the ribs can have a chamfer angle, which is approximately identical to the chamfer angle of the guide protrusions or guide receptacles, respectively, in particular lie between 30 degrees and 80 degrees. The further properties of the chamfer, in turn, can correspond to those of the guide protrusions or guide receptacles, respectively.

Based on each of the above-mentioned possible embodiments, it can furthermore be provided that the tool part has two or more receiving regions, which lie next to one another in the same movement plane, in which the tool parts can be brought together. The pair of tool parts is thus not only suitable for a single specified pressed part size but for different sizes of pressed parts or cables, respectively. Depending on the size of the pressed part, a different one of the two or more receiving regions of the tool part can be selected thereby in order to press the pressed part with the cable core of the cable.

In particular, a pair of tool parts is preferred, in the case of which, with the exception of a central receiving region, two identical receiving regions are formed in each case symmetrically to a central receiving region. It is possible thereby that one of the tool parts can be inserted into a tool jaw so as to be offset by 180 degrees, while the other tool part is not offset. The orientation of one or both tool parts can thus be changed by 180 degrees, wherein the two tool parts within the pair of tool parts each match one another so that they can be opened and brought together. In particular, a point symmetry of each of the tool parts exists with respect to its receiving region. A tool part comprising, for example, three receiving regions can thus have a central receiving region and two outer receiving regions, wherein the two outer receiving regions are formed identically to one another. For example, the two outer receiving regions can receive larger pressed parts than the central receiving region. In the case of tool parts comprising an even number of receiving regions, the two outermost receiving regions are formed identically to one another. The two inner receiving regions, in contrast, are likewise formed identically to one another. An offsetting of a first tool part by 180 degrees is thus also possible in this respect, while the second tool part is not offset by 180 degrees. The user can insert pressed parts of a certain diameter into an outer receiving region as usual, regardless of the orientation, in which the tool part is inserted into a tool jaw.

The pressing tool can have at least one first tool jaw, which can be linearly displaced relative to a second tool jaw, or, alternatively, at least one first tool jaw, which can be pivoted about a pivot axis. In this context, either only one tool jaw or both tool jaws can furthermore be displaced relative to one another. Embodiments are also possible, in the case of which one of the tool jaws is stationary relative to a base body of the pressing tool.

Particularly preferably, the pressing tool is driven electro-hydraulically. The drive of the tool jaws thereby takes place, for example, by means of a hydraulically actuatable piston/cylinder assembly, wherein the hydraulic means can be acted upon by means of an electric pump and assigned control unit. An accumulator can furthermore in particular be provided for the energy supply.

The electrical energy can be provided directly by means of a cable connection or by means of an accumulator, which is preferably integrated into the tool.

According to the invention, a pair of tool parts is lastly proposed for a pressing tool. The features of the tool parts have been described above with regard to the pressing tool. To avoid a repetition, reference is made to the preceding description parts relating to the tool parts as such.

### BRIEF DESCRIPTION OF THE DRAWINGS

The invention is described below on the basis of the enclosed drawings, which only represent exemplary embodiments. A part, which is described only based on one of the exemplary embodiments and which is not replaced with another part in a further exemplary embodiment due to the special feature emphasized there, is thus also described for the further exemplary embodiment as at least possible present part. In the drawings:

FIG. 1 shows, in perspective illustration, a pressing tool according to a first embodiment comprising a pair of tool parts arranged in tool jaws;

FIG. 2 shows an enlarged partial region of the region II in FIG. 1;

FIG. 3 shows a side view of the partial region according to FIG. 2;

FIG. 4 shows a view according to the section of the line D in FIG. 3;

FIG. 5 shows, in perspective illustration, a pair of tool parts relating to a further embodiment;

FIG. 6 shows a pressing tool according to a further embodiment;

FIG. 7 shows a pair of tool parts relating to a further embodiment in perspective illustration;

FIG. 8 shows one of the tool parts according to FIG. 7 in perspective view;

FIG. 9 shows a radial top view onto the pair of tool parts according to FIG. 7 in open initial position of the tool parts;

FIG. 10 shows the tool parts according to FIG. 9 in a brought-together end position of the tool parts;

FIG. 11 shows a side view of the tool parts in the end position;

FIG. 12 shows, in perspective illustration, a pressing tool comprising a pair of tool parts for crimping a pressed part, relating to a further embodiment;

FIG. 13 shows the pair of tool parts of the embodiment according to FIG. 12 in a perspective individual illustration;

FIG. 14 shows the front view against the tool parts according to arrow XIV in FIG. 13;

FIG. 15 shows the view against the tool parts according to arrow XV in FIG. 14;

FIG. 16 shows the section according to the line XVI-XVI in FIG. 15;

FIG. 17 shows the section according to FIG. 16, relating to a brought-together position;

FIG. 18 shows a pair of tool parts according to a further embodiment in an open initial position (sectional view);

FIG. 19 shows the pair of tool parts according to FIG. 18 in a brought-together end position.

### DESCRIPTION OF THE EMBODIMENTS

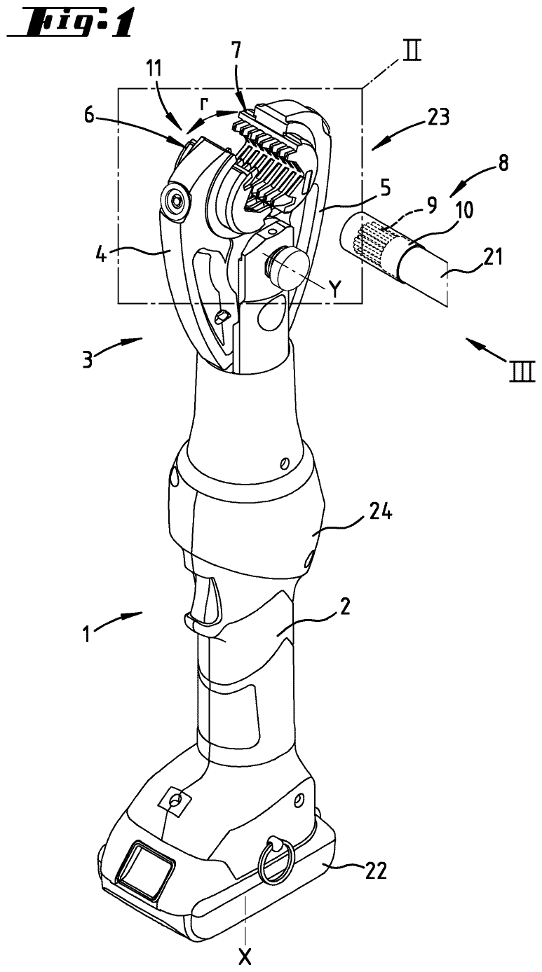

What is illustrated and described, initially with reference to FIG. 1, is a pressing tool 1 according to a possible embodiment, which is formed here only in an exemplary manner in the shape of an essentially rod-like drive device part comprising a housing 24, a handle region 2 and a working head 3. Alternatively, the pressing tool 1 can also be formed as an essentially gun-shaped drive device part.

Two tool jaws 4, 5, which are mounted so as to be capable of being pivoted relative to one another about a pivot axis Y, are arranged in the working head 3, wherein each of the pivotably movable tool jaws 4, 5 is moved towards the other opposite tool jaw 4, 5 during the operation of the pressing tool 1. This movement will be described below as bringing-together of the tool jaws 4, 5. The drive of the tool jaws 4, 5 takes place electro-hydraulically, for example, for the purpose of which an accumulator 22 can further for example be provided on the end side of the handle region 2, which accumulator can further also serve the purpose of electrically supplying, for example, a hydraulic medium pump and a control unit.

Drive device parts or pressing tools 1, respectively, of this type are known, for example, from the WO 2008/138987 A2 (U.S. Pat. No. 8,056,473 B2) or also from the WO 2003/084719 A2 (U.S. Pat. No. 7,254,982 B2). The pressing tool 1 can alternatively have an electromotive spindle drive. Such a pressing tool 1 is known, for example, from the WO 2014/009363 A1 (U.S. Pat. No. 10,468,847 B2). The content of these publications is hereby included in its entirety into the disclosure of the present invention, also for the purpose of including features of these WO publications or US publications, respectively, in claims of the present invention.

The tool jaws 4, 5 are preferably carriers of changeable tool parts 6, 7, wherein a screwing or latching fixation of the tool parts 6, 7 is preferred in the assigned tool jaws 4, 5. The tool parts 6, 7 of such a pair can, and as preferred, be designed identically, so that a firm assignment of a tool part 6, 7 to a certain tool jaw 4, 5 is not mandatory. The tool parts 6, 7 are furthermore designed so that they can be inserted into the tool jaw 4, 5 so as to be rotated by 180 degrees and a compatibility to the other (non-rotated) tool part 6, 7 is nonetheless given. This will be discussed later separately.

The tool parts 6, 7 of the embodiments illustrated in the following figures are formed for crimping a pressed part 10 with a cable core 9 of a cable 8, which is at least partially stripped of an insulation sheath 21. The pressed part 10 is, for example, a cable shoe or a cable end sleeve. Such a cable 8 furthermore has a cable core 9 in the usual way preferably comprising a plurality of strands as well as the insulation sheath 21 surrounding the cable core 9. In order to be able to establish an electrically conductive connection of the cable 8, the cable core 9 needs to initially be exposed in an end-side section of the cable 8 by removing the insulation sheath 21.

In a section viewed transversely to a longitudinal extension of a cable 8 or pressed part 10, respectively, guided between the tool parts 6, 7, each tool part 6, 7 has a receiving region 11, by means of which each tool part 6, 7 encloses the cable 8 or the pressed part 10, respectively, essentially semi-circularly, in response to brought-together tool parts 6, 7. The two receiving regions 11 of the tool parts 6, 7 preferably complement one another accordingly to a receptacle, which is essentially circular cylindrical as a whole, in a brought-together state of the tool parts 6, 7.

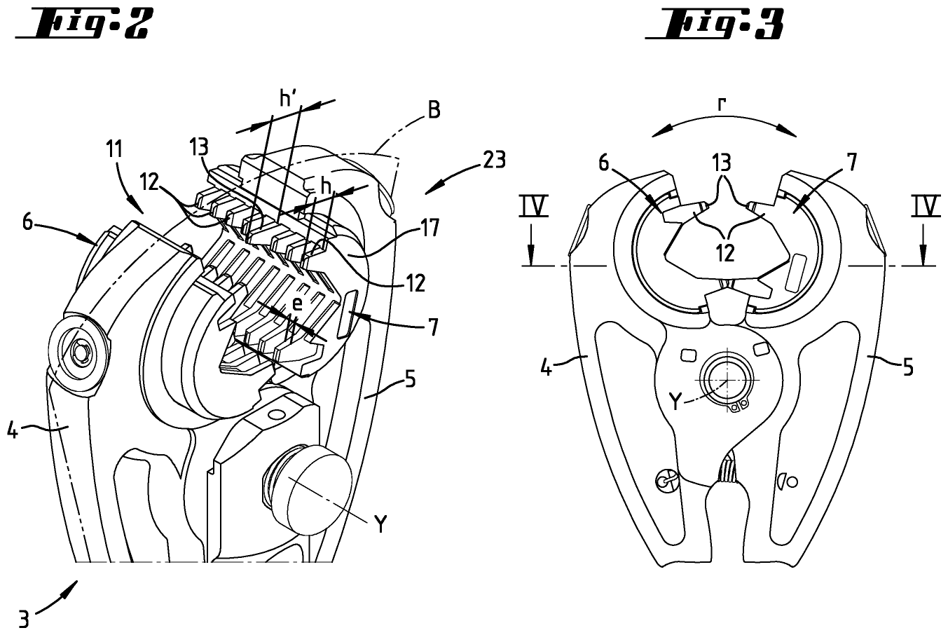

The end region facing away from the accumulator 22 in the housing 24 of the pressing tool 1 forms a working region 23. In the working region 23, the two tool jaws 4, 5 can be displaced towards one another in the bringing-together direction r from an open initial position into a brought-together end position. The FIGS. 1 to 4 relate to the initial position of the tool jaws 4, 5 of the pressing tool 1 illustrated in FIG. 1. The tool jaws 4, 5 can be pivoted from the open initial position (open position) into the brought-together end position (closed position). For this purpose, an application part (not illustrated in more detail) is provided, which can be displaced along an axis x directed transversely to the alignment of the pivot axis Y. This application part can be movable in a motorized manner, in particular electromotively. The pivotal displacement of the tool jaws 4, 5 and thus of the tool parts 6, 7 in the direction of the end position can be given against the resetting force of a spring, which is not illustrated in more detail.

The bringing-together direction r lies in or parallel, respectively, to a movement plane B, which runs centrally through the tool parts 6, 7, for example based on a longitudinal direction of the cable 8 received in the working region 23.

As follows from the illustrations in particular of the FIGS. 2 and 4, the opposite tool parts 6, 7 have a plurality of ribs 12, which are arranged parallel to one another and one behind the other in a direction orthogonally to the movement plane B. The ribs 12 have a height extension h and a longitudinal extension e. In the open position illustrated in FIG. 2, the ribs are spaced apart from one another, wherein the ribs 12 of the first tool part 6 can engage between the ribs 12 of the second tool part 7 in response to a bringing-together of the opposite tool parts 6, 7, and vice versa. In a cross section orthogonally to the movement plane B, the ribs 12 have a rectangular shape with two long and two short sides, wherein the long sides are oriented parallel to one another and parallel to the bringing-together direction r or movement plane B, respectively. It can also be a rectangle with sides of rather identical lengths, thus a square.

In addition to the ribs 12, each tool part 6, 7 has one or several guide protrusions 13, which are preferably arranged between the ribs 12 and/or formed as elevational appendage of a rib, the front regions 14 of which protrude beyond end-side front regions 18 of the ribs 12. The guide protrusions 13 thus have a height extension h′, which is greater than the height extension h of the ribs 12.

Each tool part 6, 7 has two guide protrusions 13 here, wherein the guide protrusions 13 are positioned and oriented on the tool part 6, 7 so that they lie opposite one another point-symmetrically, based on a center of symmetry of the respective tool part 6, 7. The point-symmetrical design of the tool parts 6, 7 provides for an arrangement of the tool part 6, 7, which is rotated by 180 degrees, in the assigned tool jaw 4, 5, so that the compatibility with the other tool part 6, 7 (which was not rotated accordingly) is always maintained.

The shape of the guide protrusions 13 based on a cross section orthogonally to the movement plane B preferably corresponds to the shape of a rectangle with two long and two short sides. The long sides of the guide protrusions 13 are oriented parallel to one another and also parallel to the movement plane B and the long sides of the ribs 12.

The tool parts 6, 7 are furthermore formed so as to correspond to one another in such a way that, as a whole, they likewise form a point-symmetrical unit in response to the brought-together end position of the working head 3.

As can be seen from the figures, each tool part 6, 7 essentially has a semi-circular shape with respect to its outer surface, which can preferably simultaneously form a contact region to the receptacle in the tool jaw 4, 5, wherein the semi-circle furthermore merges into a row of ribs 12 arranged one behind the other (based on a direction orthogonally to the movement plane B).

In the respective row of ribs 12, a rib 12 is replaced by a guide protrusion 13. The front region 14 of the guide protrusions 13 as well as the front regions 18 of the ribs 12 are preferably chamfered, so that a lateral offset of the tool parts 6, 7 can take place when a guide protrusion 13 of the first tool part 6 meets a rib 12 of the second tool part 7, in order to avoid an obstruction or blockade, respectively, of the tool parts 6, 7. The guide protrusions 13 thus serve the purpose of guiding the bringing-together movement as well as the purpose of the centering cooperation.

The guide protrusions 13 can likewise be formed as ribs, pins or similar protrusions. They preferably have essentially the same basic shape as the adjacent ribs 12. The guide protrusion 13 as well as the ribs 12 are preferably formed from the same material as a base body 17 of the tool part 6, 7. In particular, there is preferably a one-piece formation of the tool part 6, 7, including the ribs 12 and guide protrusions 13.

The ribs 12 and/or guide protrusions 13 can be present, for example, in tapered or conical design. In the cross section, they can be, for example, polygonal, in particular square or triangular. However, circular or oval designs are also conceivable. In the shown exemplary embodiment, the ribs 12 or guide protrusions 13, respectively, exist only on respective opposite outer edges of the receiving region 11 of the respective tool part 6, 7. Only a partial surface of the ribs 12 or of the guide protrusions 13, respectively, preferably forms a surface of the receiving region 11.

All of the FIGS. 1 to 5 show the moved-apart initial position of the tool parts 6, 7 prior to a pressing process. At least a guide protrusion 13 of the one tool part 6, 7 is thereby completely disengaged from the guide receptacle 15 of the other tool part 6, 7. The ribs 12 are preferably also completely disengaged. Disengaged means here that no overlap is given between the guide protrusions 13 and/or the ribs 12 based on a view orthogonally to the reference plane B.

As can in particular be seen in the FIG. 4, adjacent ribs 12 of the same tool part 6, 7 form a guide receptacle 15 for a guide protrusion 13 of the corresponding opposite other tool part 6, 7. This means that, for example, a guide protrusion 13 of the first tool part 6 engages between two adjacent ribs 12 of the second tool part 7. Due to the front regions 18 of the ribs 12, which are likewise chamfered here, for example, the guide receptacle 15 created in this way has a chamfered opening region 16. This makes it possible for opposite ribs 12 and guide protrusions 14 to glide along one another in response to a bringing-together of the tool parts 6, 7. The guide receptacles 15 are thus formed by means of circumferential surfaces of adjacent ribs 12, which define a limited free space with one another, with which a guide protrusion 13 of the other tool part 6, 7 can engage.

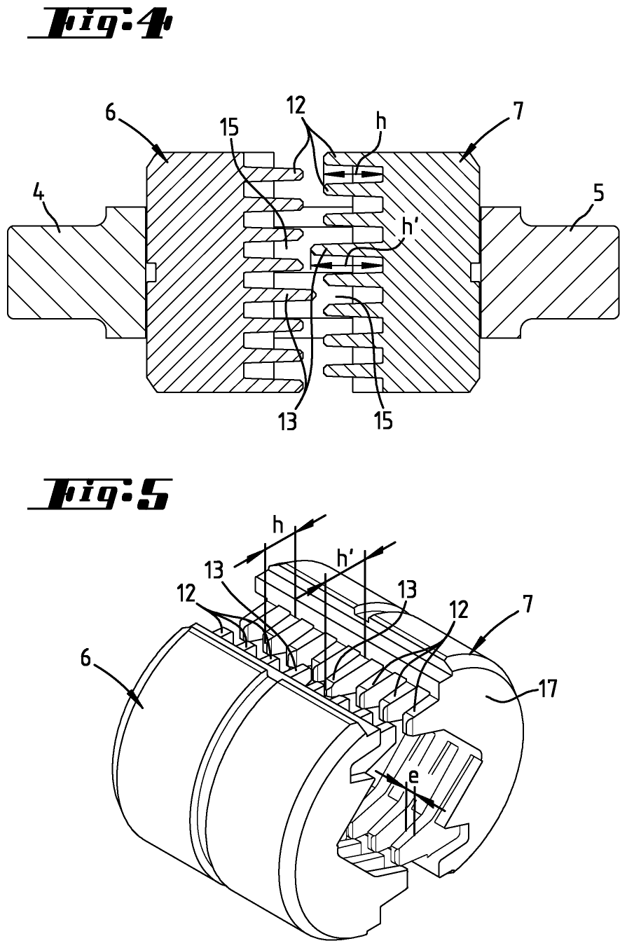

The FIG. 5 alternatively shows pair of tool parts 6, 7, which is likewise formed with ribs 12 and guide protrusions 13 and which is formed for a pressing tool 1, in the case of which the tool jaws 4, 5 are moved linearly towards one another. For example, the FIG. 6 shows such a pressing tool 1.

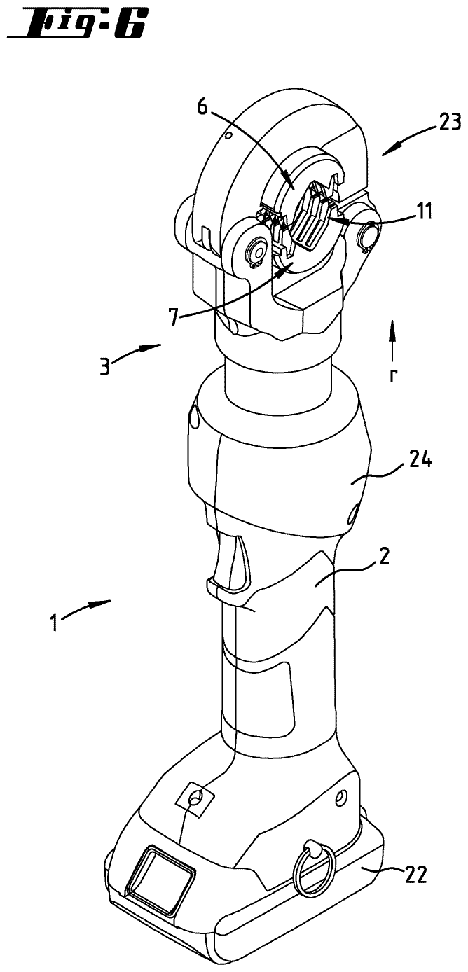

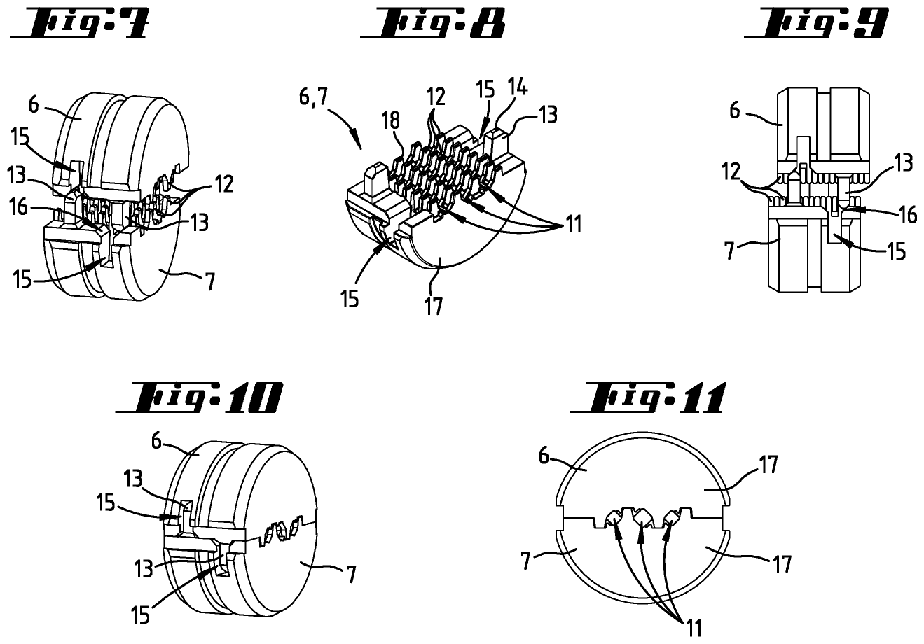

The FIGS. 7 to 11 show a pair of tool parts 6, 7 according to a further possible embodiment of the invention. According to this embodiment, the tool parts 6, 7 have guide protrusions 13, which are positioned outside of an arrangement of consecutive ribs 12. According to this embodiment, the tool parts 6, 7, in turn, also have a semicircular shape with respect to a receiving surface, wherein several rows of ribs 12 are arranged here parallel to a movement plane B as well as orthogonally thereto.

Based on a viewing direction of the respective tool part 6, 7 in a direction orthogonally to the movement plane B or the bringing-together direction r, respectively, the guide protrusions 13 are arranged in an outer edge region relative to the arrangement of ribs 12. The base body 17 of the tool parts 6, 7 thus has a radially outer, separate region for the guide protrusions 13. This separate partial region furthermore has guide receptacles 15, with which a corresponding guide protrusion 13 of the respective other tool part 6, 7 can engage.

Based on the bringing-together direction r of the tool parts 6, 7, the opening regions 16 of the guide receptacles 15 lie upstream of the front regions 18 of the ribs 12 during a bringing-together. For example, a front region 14 of a guide protrusion 13 of the first tool part 6 thus reaches into the opening region 16 of the corresponding guide receptacle 15 of the second tool part 7 before the opposite ribs 12 of first tool part 6 and second tool part 7 can become engaged with one another. According to this design, a guidance and centering of the tool parts 6, 7 takes place parallel to the movement plane B as well as orthogonally thereto.

The positions of the guide protrusions 13 as well as of the corresponding opening regions 16 of the guide receptacles 15 on the base body 17 of the respective tool part 6, 7 are furthermore also selected so that, on the one hand, they are point-symmetrically for each tool part 6, 7 itself as well as based on the respective other tool part 6, 7.

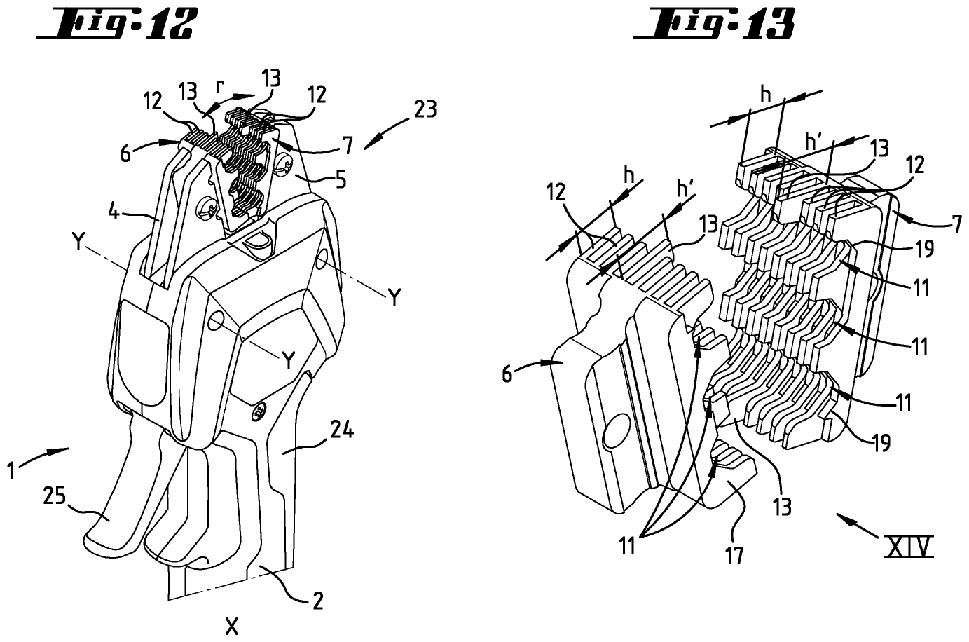

In comparison, the FIGS. 7 to 9 relate to the moved-apart initial state of the tool parts 6, 7 when the pressing tool 1 is open, in the case of which the guide protrusions 13 and the guide receptacles 15 are not yet engaged with one another. The FIGS. 10 and 11, in contrast, show a brought-together state.

As can furthermore be seen in the FIGS. 7 to 11, each tool part 6, 7 can have several receiving regions 11, namely three separate receiving regions 11 here, which can serve the purpose of pressing pressed parts 10 or cables 8, respectively, of different sizes. As can in particular be seen in the FIGS. 10 and 11, the receiving regions 11 have a square cross section when the tool parts 6, 7 are brought together. Within the square receiving region 11, a pressed part 10 of a first circumferential length can be pressed in an open initial position of the tool parts 6, 7 to a second smaller circumferential length in a closed end position of the tool parts 6, 7.

The above-described guidance and centering according to the invention by means of the cooperation of the guide protrusions 13 with the corresponding guide receptacles 15, however, is independent of the cross sectional shape of the receiving region 11, which is specified only as a possible embodiment here.

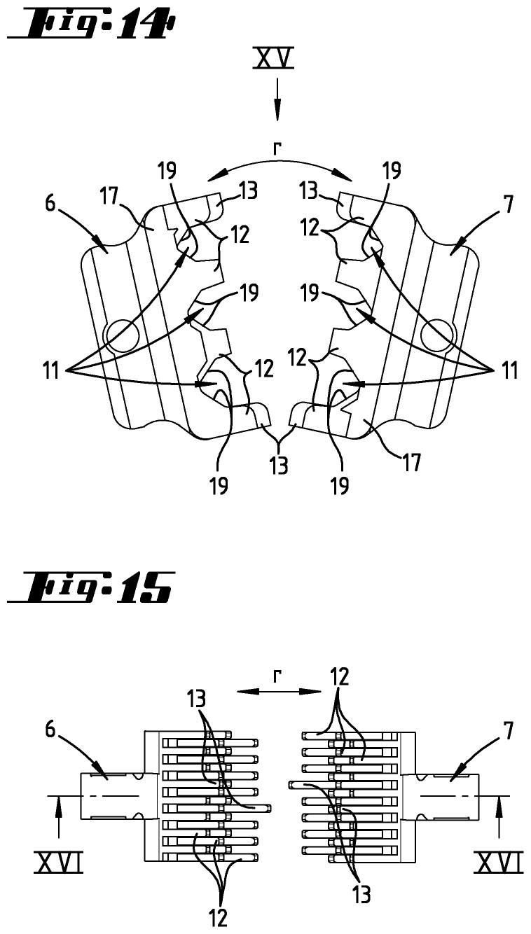

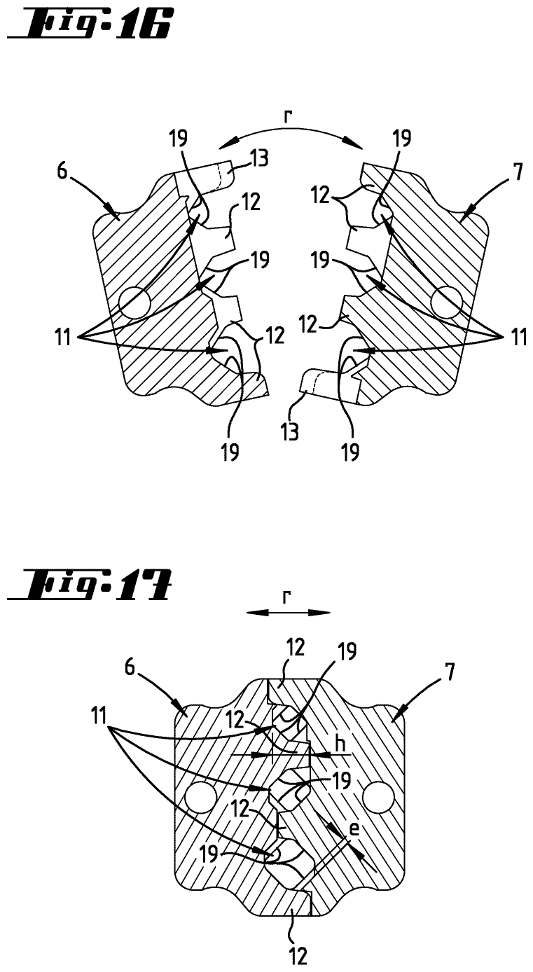

The FIGS. 12 to 17 show a further embodiment of the invention, in the case of which in particular the formation of the ribs 12 as well as of the receiving regions 11 of the tool parts 6, 7 for crimping the pressed part 10 is observed in more detail.

What is illustrated is a further possible embodiment of a pressing tool 1. The pressing tool 1 of this embodiment can be, for example, a pressing tool according to the WO 2014/009363 A1 (US 2015/0251256 A1). The content of this patent application is hereby also included in its entirety into the disclosure of the present invention, also for the purpose of including features of this patent application into claims of the present invention.

In rod-shaped arrangement one behind the other, received in a housing 24, the pressing tool 1 can thus have an electric motor and a gear unit. To supply the electric motor, an accumulator 22 (not illustrated here) is arranged on the end side of the pressing tool 1.

The end region facing away from the accumulator 22 of the pressing tool 1, which is preferably rod-shaped as a whole, forms a working region 23. In the embodiment according to the FIGS. 12 to 17, said working region is given by two tool jaws 4, 5, which are movable about pivot axes Y running parallel to one another.

The tool jaws 4, 5 can essentially be designed identically and carry tool parts 6 and 7 facing one another in the shape of pressing jaws. The tool parts 6 and 7 are preferably held exchangeably on the tool jaws 4, 5.

The tool jaws 4, 5 can be pivoted from an initial position (open position) according to FIG. 12 into an end position (closed position). For this purpose, an application part is provided, which can be displaced along an axis x directed transversely to the alignment of the pivot axis Y. This application part can initially be movable here by means of manual force via a lever part 25 and furthermore in a motorized manner, in particular electromotively.

The pivotal displacement of the tool jaws 4, 5 and thus of the tool parts 6 and 7 in the direction of the end position can be given against the resetting force of a spring.

The tool parts 6 and 7 are preferably designed identically, each have a receiving region 11 for a cable 8 or for a cable end, respectively, provided with a pressed part 10. The formation of a plurality of receiving regions 11 on the tool parts 6 and 7 is not limited to, as illustrated, pivotable tool parts 6 and 7, in the same way as the formation of only one receiving region 11 is not limited solely to linearly displaceable tool parts. In the case of linearly displaceable tool parts 6 and 7, several receiving regions 11, preferably of different sizes, can in fact also be provided here, as it is also possible in the case of pivotable tool parts 6 and 7 to form them with only one receiving region 11.

The tool parts 6 and 7 have ribs 12 in particular in the receiving region 11 or assigned to the receiving regions 11, respectively, with a height extension h, viewed in the bringing-together direction r of the tool parts 6 and 7. Combined, the receiving regions 11 form a pressing mouth.

The ribs 12 are preferably fastened to a base body 17 of each tool part 6, 7, for example as a result of a formation in one piece and from the same material. Together, two ribs 12 arranged one behind the other orthogonally to the height extension h, form the receiving region 11 or the plurality of receiving regions 11, respectively, in a projection into a common plane.

The ribs 12 of a tool part 6 or 7, respectively, are thereby provided spaced apart from one another orthogonally to the height extension h of the ribs 12, wherein the corresponding distance in the above-described direction essentially corresponds to the longitudinal extension e of a rib 12, viewed in the same direction. An entrance opening (guide receptacle 15) for the ribs 12 of the opposite tool part 6, 7 accordingly results between two ribs 12.

In the case of a tool part 6, 7 comprising several receiving regions 11 according to the FIGS. 12 to 17, the dimensions of the receiving regions are selected differently in this brought-together end position of the tool parts 6 and 7, in order to provide for the crimping of pressed parts 10 with different diameters. Such a receiving region 11 can thereby be designed exclusively for a specified pressing part diameter.

In particular, tool parts 6, 7 comprising several receiving regions 11 are preferred, in the case of which—as illustrated in the FIGS. 18 and 19—two outer receiving regions 11 and one central receiving region 11 are formed. Based on the view according to the FIGS. 18 and 19, the two outer receiving regions 11 have a larger cross section than the inner, central receiving region. Due to the symmetrical formation, the user can insert one of the tool parts 6, 7 into the corresponding tool jaw 4, 5 so as to be offset by 180 degrees (in the case of simultaneously non-offset further tool jaw 4, 5), without the bringing-together of the tool parts 6, 7 being obstructed. Based on the illustration of the FIG. 19, for example, the first tool part 6 can be offset by 180 degrees, while the second tool part 7 remains unchanged, wherein the corresponding shape of the tool parts 6, 7 as a whole is not changed. The user of a pressing tool 1 equipped in this way has to in particular not pay attention to whether, based on the illustration according to FIG. 19, a pressed part 10 has to be inserted into the upper receiving region 11 or into the lower receiving region 11. Instead, the two outer receiving regions 11 are formed identically to one another and can therefore press identical pressed parts 10. The central receiving region 11, in contrast, is suitable for pressed parts 10 with smaller diameter.

Even though this is not illustrated in more detail in the figures, tool parts 6, 7 comprising more than three receiving regions 11 can also be provided, wherein tool parts 6, 7 with an odd number of receiving regions 11 in each case have an individual central receiving region 11, which provides a different cross section for pressed parts 10 than the remaining receiving regions 11, which are in each case present in pairs. In the case of tool parts 6, 7 with an even number of receiving regions 11, an individual inner receiving region 11 does not exist, so that the tool parts 6, 7 are in each case formed with two, three, four or more pairs of receiving regions 11. It is essential that an offset by 180 degrees of one of the tool parts 6, 7 is always possible, while the other tool part 6, 7 is not offset.

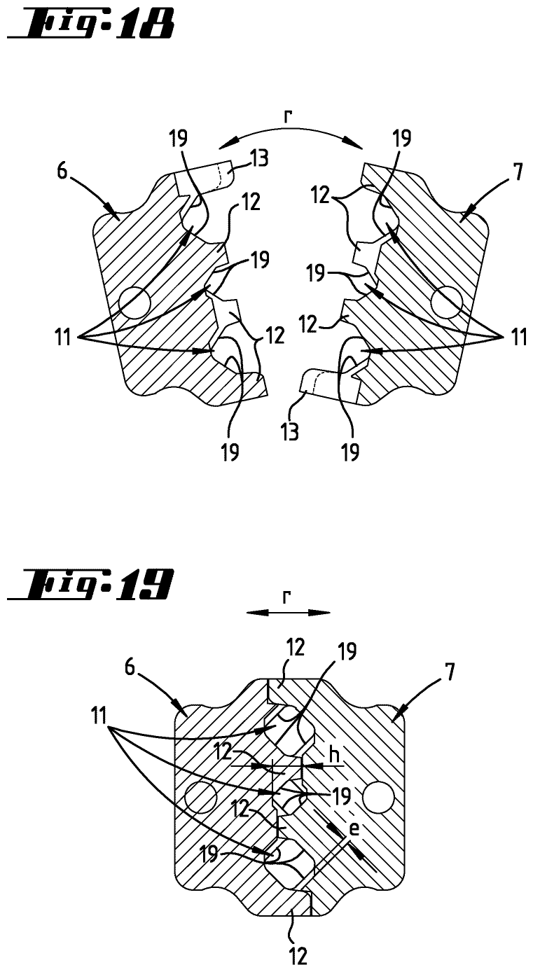

In the brought-together position illustrated in the FIGS. 17 and 19, which corresponds to the pressed position of a pressed part 10, an essentially square cross section of the receiving region 11 results.

With their receiving regions 11, the tool parts 6 and 7 are in particular designed for pressing an initially sleeve-shaped pressed part 10 with an initial cross section having a first circumferential length. Such a pressed part 10 is placed over the cable end freed from the insulation sheath 21, so that the pressed part 10 encompasses the exposed cable core 9.

In this arrangement position, the cable end is moved with the pressed part 10 into the receiving region 11 when tool parts 6 and 7 are located in the open position. As a result of bringing together the tool parts 6 and 7, the receiving region 11 deforms a wall 20 of the pressed part 10 over the outer edges 19 of the ribs 12, starting at the preferably circular initial cross section with the first circumferential length, in a square end cross section corresponding to the square cross sectional design of the receiving region 11, compared to the initial circumferential length of a smaller circumferential length.

A pressing of this type of the pressed part 10 preferably takes place via the entire depth of the tool parts 6 and 7, viewed transversely to the height extension h of the ribs 12.

The above explanations serve the purpose of describing the inventions captured by the application as a whole, which further develop the prior art at least by means of the following feature combinations, in each case also independently, wherein two, several or all of these feature combinations can also be combined, namely:

A pressing tool 1, which is characterized in that the tool parts 6, 7 comprising the tool jaws 4, 5 pivot on the circular path in response to the bringing together and that the guide protrusion 13 of the one tool part 6, 7 in the open position is outside of the guide receptacle 15 of the other tool part 6, 7 in the bringing-together direction r, and wherein the guide protrusion 13 moves into the guide receptacle 15 as part of the bringing together.

A pressing tool 1, which is characterized in that the ribs 12 have a height extension h in the bringing-together direction r.

A pressing tool 1, which is characterized in that the guide protrusion 13 is formed as lengthening of the rib 12 in the bringing-together direction r.

A pressing tool 1, which is characterized in that based on a cross section orthogonally to a height extension h′ of the guide protrusions 13, the guide protrusions 13 have an essentially rectangular shape with two long sides and two short sides, wherein the long sides are oriented parallel to a movement plane B, in which the tool parts 6, 7 can be brought together and parallel to the ribs 12, and wherein the ribs 12 and guide protrusions 13 of the opposite tool parts 6, 7 are completely disengaged from one another in an open state of the pressing tool 1.

A pressing tool 1, which is characterized in that based on a cross section orthogonally to a height extension h′ of the guide protrusions 13, the guide protrusions have an essentially rectangular shape with two long sides and two short sides, wherein the long sides are oriented parallel to the movement plane B and parallel to the ribs 12.

A pressing tool 1, which is characterized in that the ribs 12 and guide protrusions 13 of the opposite tool parts 6, 7 are completely disengaged from one another in an open state of the pressing tool 1.

A pressing tool 1, which is characterized in that the tool parts 6, 7 have guide receptacles 15, which correspond in shape to the guide protrusions 13, wherein the first tool part 6 has a guide protrusion 13 and wherein the second tool part 7 has a corresponding guide receptacle 15 for receiving the guide protrusion 13 of the first tool part 6.

A pressing tool 1, which is characterized in that the guide receptacle 15 has a chamfered opening region 16.

A pressing tool 1, which is characterized in that the guide receptacle 15 is a material recess within a base body 17 of the tool part 6, 7, which carries the ribs 12.

A pressing tool 1, which is characterized in that the guide receptacle 15 is a free space, which is formed between adjacent ribs 12 and which is limited by the adjacent ribs 12.

A pressing tool 1, which is characterized in that the tool part 6, 7 is formed point symmetrically, so that two guide protrusions 13 and/or two guide receptacles 15 of the same tool part 6, 7 are formed so as to lie opposite point-symmetrically with respect to the receiving region 11.

A pressing tool 1, which is characterized in that the guide protrusions 13 and the guide receptacles 15 are formed outside of the receiving region 11 and/or outside of a region, which is spanned as a whole by the consecutive ribs.

A pressing tool 1, which is characterized in that the ribs 12 have chamfered front regions 18.

A pressing tool 1, which is characterized in that the tool part 6, 7 has two or more receiving regions 11, which lie next to one another in the same movement plane B, in which the tool parts 6, 7 can be brought together.

A pressing tool 1, which is characterized by at least one first tool jaw 4, which can be displaced linearly relative to a second tool jaw 5 or by at least one first tool jaw 4, which can be pivoted about a pivot axis Y.

A pressing tool 1, which is characterized in that the pressing tool 1 is driven electro-hydraulically.

A pressing tool 1, which is characterized in that based on a cross section orthogonally to a height extension h′ of the guide protrusions 13, the guide protrusions 13 have an essentially rectangular shape with two long sides and two short sides, wherein the long sides are oriented parallel to the movement plane B and parallel to the ribs 12.

A pressing tool 1, which is characterized in that each tool part 6, 7 has three or more receiving regions 11 formed next to one another, wherein the tool parts 6, 7 can also be inserted in the pressing tool 1 offset by 180 degrees and receiving regions 11, which are identical in pairs, are provided, with the exception of a central receiving region 11, so that an offsetting by 180 degrees of one of the tool parts 6, 7 is made possible without simultaneous offsetting of the other tool part 6, 7 by 180 degrees.

All of the disclosed features (alone but also in combination with one another) are essential for the invention. The disclosure content of the corresponding/enclosed priority documents (copy of the prior application) is herewith also included in its entirety in the disclosure of the application, also for the purpose of adding features of these documents into claims of the present application. With their features, the subclaims characterize, even without the features of a referenced claim, independent inventive further developments of the prior art, in particular in order to file divisional applications on the basis of these claims. The invention specified in each claim can additionally have one or several of the features, which are in particular provided with reference numerals in the above description and/or which are specified in the list of reference numerals. The invention also relates to designs, in the case of which individual features of the features mentioned in the above description are not realized, in particular insofar as they are evidently dispensable for the respective intended purpose or can be replaced by other technically equivalent means.

List of Reference Numerals

| | |
|---|---|
| 1 | pressing tool |
| 2 | handle region |
| 3 | working head |
| 4 | tool jaw |
| 5 | tool jaw |
| 6 | tool part |
| 7 | tool part |
| 8 | cable |
| 9 | cable core |
| 10 | pressed part |
| 11 | receiving region |
| 12 | rib |
| 13 | guide protrusion |
| 14 | front region |
| 15 | guide receptacle |
| 16 | opening region |
| 17 | base body |
| 18 | front region |
| 19 | outer edge |
| 20 | wall |
| 21 | insulation sheath |
| 22 | accumulator |
| 23 | working region |
| 24 | housing |
| 25 | lever part |
| B | movement plane |
| e | longitudinal extension |
| h | height extension |
| h′ | height extension |
| r | bringing-together direction |
| x | axis |
| Y | pivot axis |

1.-18. (canceled)

19. A pressing tool for crimping a pressed part formed as cable end sleeve with a cable core of a cable, comprising:
first and second tool jaws; and
a first tool part and a second tool part which can be brought together by the tool jaws in a bringing-together direction, the tool parts being exchangeably held on the tool jaws, and
wherein in response to brought-together tool parts, a receiving region for the pressed part remains in each tool part;
each tool part having a plurality of ribs assigned to the receiving region for crimping the pressed part by an application of force,
wherein, in a front view, in which a front surface providing an application of pressure onto the pressed part is reproduced as line, the ribs, based on an effective region on the pressed part, have an essentially triangular contour, wherein, in this view, two opposite triangular contours of the same tool part complement each other to two longitudinal sides, which run at an angle to one another, of a rectangle of the receiving region,
wherein the ribs further have a longitudinal extension transversely to a bringing-together direction given in the mentioned view,
wherein, in the bringing-together direction, the tool parts further have a guide protrusion protruding beyond the ribs, which come into contact with the pressed part, and a guide receptacle, for the guiding and centering cooperation as part of a bringing together of the tool parts with a guide protrusion and a guide receptacle of the respective other tool part, and
wherein the tool jaws pivot between an open position and a closed position on a circular path in response to the bringing together, that the guide protrusion of the one tool part in the open position is outside of the guide receptacle of the other tool part in the bringing-together direction, and the guide protrusion moves into the guide receptacle as part of the bringing together,
wherein the tool part including the ribs and the guide protrusion are of an one piece formation, and
wherein the guide protrusion has a chamfered front region and/or that the guide receptacle has a chamfered opening region.

20. The pressing tool according to claim 19, wherein the ribs have a height extension in the bringing-together direction.

21. The pressing tool according to claim 19, wherein the guide protrusion is formed as lengthening of the rib in the bringing-together direction.

22. The pressing tool according to claim 19, wherein based on a cross section orthogonally to a height extension of the guide protrusions, the guide protrusions have an essentially rectangular shape with two long sides and two short sides, wherein the long sides are oriented parallel to a movement plane, in which the tool parts can be brought together and parallel to the ribs, and wherein the ribs and guide protrusions of the opposite tool parts are completely disengaged from one another in an open state of the pressing tool.

23. The pressing tool according to claim 19, wherein the guide receptacles correspond in shape to the guide protrusions.

24. The pressing tool according to claim 23, wherein the guide receptacle is a free space, which is formed between adjacent ribs and which is limited by the adjacent ribs.

25. The pressing tool according to claim 23, wherein the guide receptacle is a material recess within a base body of the tool part, which carries the ribs.

26. The pressing tool according to claim 19, wherein the guide protrusions and the guide receptacles are formed outside of the receiving region and/or outside of a region, which is spanned as a whole by the consecutive ribs.

27. The pressing tool according to claim 19, wherein the tool part has two or more receiving regions, which lie next to one another in the same movement plane, in which the tool parts can be brought together.

28. The pressing tool according to claim 19, wherein the pressing tool is driven electro-hydraulically.

29. A pressing tool for crimping a pressed part formed as cable end sleeve with a cable core of a cable, comprising:
first and second tool jaws; and
a first tool part and a second tool part which can be brought together by the tool jaws in a bringing-together direction, the tool parts being exchangeably held on the tool jaws, and
wherein in response to brought-together tool parts, a receiving region for the pressed part remains in each tool part,
wherein each tool part has a plurality of ribs assigned to the receiving region for crimping the pressed part by an application of force,
wherein a height extension of the ribs is directed in the direction of the opposite tool part,
wherein, viewed orthogonally to a movement plane, in which the tool parts can be brought together, the tool parts have guide protrusions protruding beyond the ribs which come into contact with the pressed part in the bringing-together direction for the guiding and centering cooperation as part of a bringing together of the tool parts, and
wherein, based on a cross section orthogonally to a height extension of the guide protrusions, the guide protrusions have an essentially rectangular shape with two long sides and two short sides,
wherein the long sides are oriented parallel to the movement plane and parallel to the ribs, that the tool part including the ribs and the guide protrusions are of an one piece formation and that the guide protrusions have a chamfered front region,
wherein the ribs and guide protrusions of the opposite tool parts are completely disengaged from one another in an open state of the pressing tool, and
wherein the first tool jaw can be displaced linearly relative to the second tool jaw.

30. The pressing tool according claim 29, wherein the tool parts have guide receptacles, which correspond in shape to the guide protrusions, wherein the first tool part has a guide protrusion and wherein the second tool part has a corresponding guide receptacle for receiving the guide protrusion of the first tool part.

31. The pressing tool according to claim 29, wherein the guide receptacle has a chamfered opening region.

32. The pressing tool according to claim 31, wherein the guide receptacle is a material recess within a base body of the tool part, which carries the ribs.

33. The pressing tool according to claim 32, wherein the guide receptacle is a free space, which is formed between adjacent ribs and which is limited by the adjacent ribs.

34. The pressing tool according claim 31, wherein the tool part is formed point symmetrically, so that two guide protrusions and/or two guide receptacles of the same tool part are formed so as to lie opposite point-symmetrically with respect to the receiving region.

35. The pressing tool according to claim 31, wherein the guide protrusions and the guide receptacles are formed outside of the receiving region and/or outside of a region, which is spanned as a whole by the consecutive ribs.

36. The pressing tool according to claim 31, wherein the tool part has two or more receiving regions, which lie next to one another in the same movement plane, in which the tool parts can be brought together.

37. The pressing tool according to claim 31, wherein the pressing tool is driven electro-hydraulically.

38. The pair of tool parts for use with a pressing tool for crimping a pressed part formed as cable end sleeve with a cable core of a cable, and including two tool jaws, which can be brought together, for exchangeably holding the tool parts, the pair of tool parts comprising:
a first tool part and a second tool part, which can be brought together by the tool jaws in a bringing-together direction,
wherein in response to brought-together tool parts, a receiving region for the pressed part remains in each tool part,
wherein the tool parts each have a plurality of ribs assigned to the receiving region for crimping the pressed part by an application of force,
wherein a height extension of the ribs is directed in the direction of the opposite tool part, and
wherein each tool part has three or more receiving regions formed next to one another,
wherein the tool parts can also be inserted in the pressing tool offset by 180 degrees,
wherein the tool parts, viewed orthogonally to a movement plane, in which the tool parts can be brought together, have guide protrusions protruding beyond the ribs, which come into contact with the pressed part, in the bringing-together direction, for the guiding and centering cooperation as part of a bringing together of the tool parts,
wherein receiving regions, which are identical in pairs, are provided, with the exception of a central receiving region, so that an offsetting by 180 degrees of one of the tool parts is made possible without simultaneous offsetting of the other tool part by 180 degrees,
wherein the tool part including the ribs and the guide protrusions are of an one piece formation,
wherein the guide protrusions have a chamfered front region, and
wherein the tool part is formed point symmetrically, so that two guide protrusions of the same tool part are formed so as to lie opposite point-symmetrically with respect to the receiving region.
